(19) United States
(12) Patent Application Publication
(10) Pub. No.: US 2024/0337141 A1
(43) Pub. Date: Oct. 10, 2024

(54) FITTING FOR MOVABLY MOUNTING A PIVOTING ELEMENT

(71) Applicant: Julius Blum GmbH, Hoechst (AT)

(72) Inventor: Stefan Duer, Schwarzach (AT)

(21) Appl. No.: 18/748,970

(22) Filed: Jun. 20, 2024

Related U.S. Application Data
(63) Continuation of application No. PCT/AT2022/060448, filed on Dec. 16, 2022.

(30) Foreign Application Priority Data
Dec. 21, 2021 (AT) A 51028/2021

(51) Int. Cl. E05D 3/18

(52) U.S. Cl. CPC E05D 3/18; E05Y 2900/20

(57) ABSTRACT

A fitting includes a first fitting part on a stationary carrier and a second fitting part on a pivoting element so that the fitting parts are movable relative to each other. An articulated lever is connected in an articulated manner to the first fitting part via a first hinge pin, and is connected in an articulated manner to the second fitting part via a second hinge pin. A guide device is linearly displaceable on or in one of the two fitting parts, and is connected in an articulated manner to the other of the two fitting parts via a third hinge pin which is separate and distanced from the first hinge pin and/or the second hinge pin. At least two articulated levers are respectively connected in an articulated manner to the first fitting part via the first hinge pin and to the second fitting part via the second hinge pin.

The present application is a continuation of International Application PCT/AT2022/060448 filed on Dec. 16, 2022. Thus, all of the subject matter of International Application PCT/AT2022/060448 is incorporated herein by reference.

### BACKGROUND OF THE INVENTION

The invention relates to a fitting for movably mounting a pivoting element, in particular a furniture part, a door, or a window, relative to a stationary support, and a piece of furniture with such a fitting.

Such a fitting is known, for example, from the applicant's own document A 50977/2018, or also from one of the documents US 2004/0252045 A1, DE 202 07 036 U1, EP 3 343 152 A1 and WO 2020/232490 A1. That document proposes a hinge mechanism with at least 5 hinge pins and several articulated levers. A disadvantage of such a fitting is the relatively complex formation of the hinge mechanism. On the one hand, this results in an increased material requirement and manufacturing effort, which brings with it higher costs. On the other hand, complex mechanics of the hinge mechanism are more prone to contamination, defects or the like.

A 50977/2018 also discloses a piece of furniture with such a hinge. A pivoting element can cover a front side of a side wall at least in sections, preferably substantially completely. In this way, in a view of the piece of furniture from the front, there is overall a smooth surface-without the formation of a step or gap, visible from the front, between the side wall and the pivoting element. This positive effect is to be retained.

### SUMMARY OF THE INVENTION

The objective technical problem of the present invention is therefore to specify a fitting that is improved compared with the state of the art, in which the disadvantages of the state of the art are at least partially remedied, and which in particular retains the above-named positive effect. In addition, a piece of furniture with such a fitting is to be specified.

A guide device is accordingly provided, wherein the guide device is mounted linearly displaceably on or in one of the two fitting parts and connected in an articulated manner to the other of the two fitting parts via a third hinge pin. The third hinge pin is formed separate and at a distance from the first hinge pin and/or the second hinge pin, and at least two, preferably precisely two, articulated levers are provided. The at least two articulated levers are in each case connected in an articulated manner to the first fitting part via the first hinge pin and in an articulated manner to the second fitting part via the second hinge pin.

The guide device makes the reduction to three hinge pins possible, as a result of which the complexity of the hinge mechanism and thus of the fitting can in turn be reduced. The arrangement of the hinge pins makes it possible for a pivoting element to cover a front side of a side wall at least in sections, preferably substantially completely.

Moreover, the pivoting element is thereby already stabilized by the fitting. In addition, a vertical load transfer can be effected via only one articulated lever.

Furthermore, a damping of a pivoting movement of the pivoting element can be easily implemented by an embedded damper in the case of a proposed fitting.

If a second articulated lever is provided, higher forces and moments can be absorbed by the articulated levers. In addition, a further articulated lever additionally stabilizes a pivoting movement of the fitting.

With respect to a piece of furniture, the piece of furniture comprises a pivoting element, a stationary support, and at least one fitting according to the invention. The pivoting element is formed as a movable furniture part, and the stationary support is formed as a furniture carcass.

According to an advantageous design of the invention, the at least one articulated lever is formed substantially L-shaped.

The L-shaped formation of the at least one articulated lever makes it possible, in conjunction with the arrangement of the hinge pins, to predefine a trajectory, along which a pivoting element can be pivoted.

The guide device can also comprise a guide element and a mounting element, wherein the guide element is mounted linearly displaceably in the mounting element.

In addition, the guide element can have a connecting section, via which the guide element is connected in an articulated manner to one of the two fitting parts via the third hinge pin.

This represents simple and uncomplicated possibilities for implementing a guide device.

According to an advantageous embodiment of the invention, the guide element can have a circular or polygonal cross-sectional area.

Depending on requirements, a cross section can thus be chosen which allows or prevents a twisting of the guide element in the mounting element.

The mounting element can comprise at least one sliding element, preferably two sliding elements.

It has in particular proved to be advantageous if the at least one sliding element is arranged in a recess in the first fitting part, wherein the guide element is guided linearly displaceably in the sliding element.

It is thereby possible to select the material of the sliding elements independently of the material of the fittings. In addition, the sliding elements can be easily replaced should any wear occur.

Preferably, the second fitting part is formed in two parts.

Particularly preferably, the second hinge pin is allocated to a first part of the second fitting, and the third hinge pin is allocated to a second part of the second fitting.

Via the two-part formation of the second fitting part, the formation of the hinge pins separately and at a distance can be easily implemented. Furthermore, material can be saved in the case of the second fitting part.

As regards a piece of furniture, the pivoting element can be moved by the fitting between a first position, in which the pivoting element at least partially covers a front side of the side wall, and a second position, in which the pivoting element can travel in a depth direction of the stationary support.

As a result, in a view of the piece of furniture from the front, there is overall a smooth surface-without the formation of a step or gap, visible from the front, between the side wall and the pivoting element. The overall visual impression of a piece of furniture is thus considerably enhanced.

Preferably, the stationary support has at least one side wall, and the pivoting element is arranged substantially parallel to the side wall in a second position.

Due to the parallel arrangement of the pivoting element with the side wall in the first position, an interior space of the piece of furniture is easily accessible in the second position.

Particularly preferably, the stationary support has at least two side walls, and the at least two side walls form a cavity, into which a pivoting element can travel in the depth direction of the stationary support in the second position.

A pivoting element is thus barely visible anymore in a second position, as a result of which on the one hand the pivoting element does not extend beyond the piece of furniture and on the other hand a visually appealing overall impression of the piece of furniture is promoted.

According to a preferred embodiment of the invention, at least two fittings according to the invention are provided. This increases the stability of a piece of furniture considerably.

### BRIEF DESCRIPTION OF THE DRAWINGS

Further details and advantages of the present invention are explained in more detail below with the aid of the description of the embodiments represented in the drawings, in which:

FIG. 1a is a perspective view of a piece of furniture in a first position,

FIG. 1b is a perspective view of a piece of furniture in a second position,

FIG. 2 is an exploded representation of a fitting,

FIGS. 3a-d are top views of a part of a piece of furniture in various steps during the transfer of the piece of furniture from a first into a second position, and

FIGS. 4a-d are perspective views of a fitting in various steps during the transfer of the piece of furniture from a first into a second position.

### DETAILED DESCRIPTION OF THE INVENTION

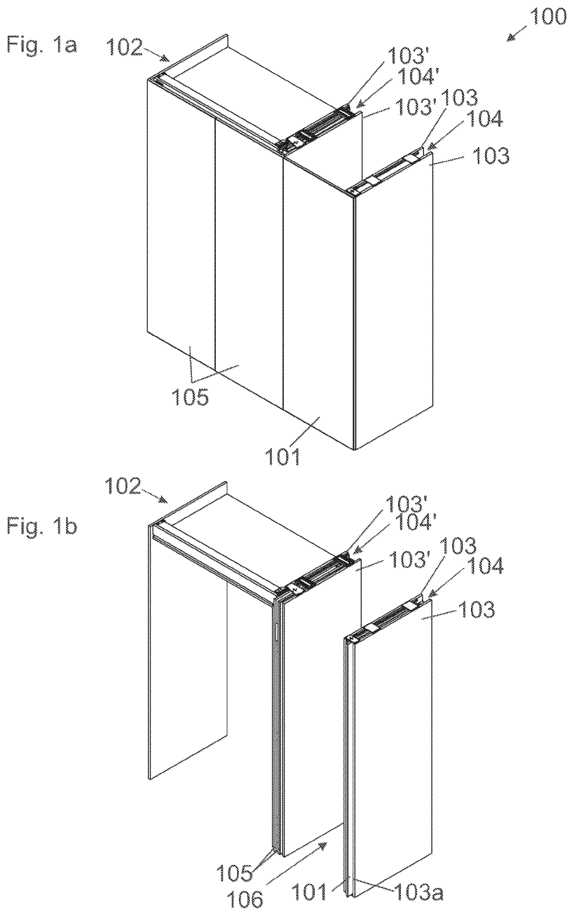

FIG. 1a shows a perspective view of a piece of furniture 100 in a first position, FIG. 1b shows the same piece of furniture 100 in a second position.

It can be seen that the piece of furniture 100 has a stationary support 102 in the form of a furniture carcass. In addition, a pivoting element 101 in the form of a door leaf is visible.

In the first position, according to FIG. 1a, the pivoting element 101 conceals a front side 103a of a side wall 103. The pivoting element 101 furthermore adjoins a folding sliding door 105 flush therewith, which results in a continuous furniture front and thus a visually appealing overall impression of the piece of furniture 100 in the first position.

It can also be seen that a second side wall 103 is provided, wherein the side walls 103 form a cavity 104.

In the second position, according to FIG. 1b, the pivoting element 101 is arranged substantially completely in the cavity 104. An interior space 106 is thus easily accessible. In addition, the pivoting element 101 does not extend into a room, with the result that the pivoting element 101 is not in the way.

In the present embodiment example, a part of the piece of furniture 100 adjoining the pivoting element 101 is equipped with a folding sliding door 105, which can be arranged in a cavity 104′ formed by two other side walls 103′.

However, it can also be provided that here no further part adjoins the pivoting element 101, i.e. that the stationary support 102 is substantially as wide as the pivoting element 101. However, several identical pivoting elements 101 can also be arranged next to each other.

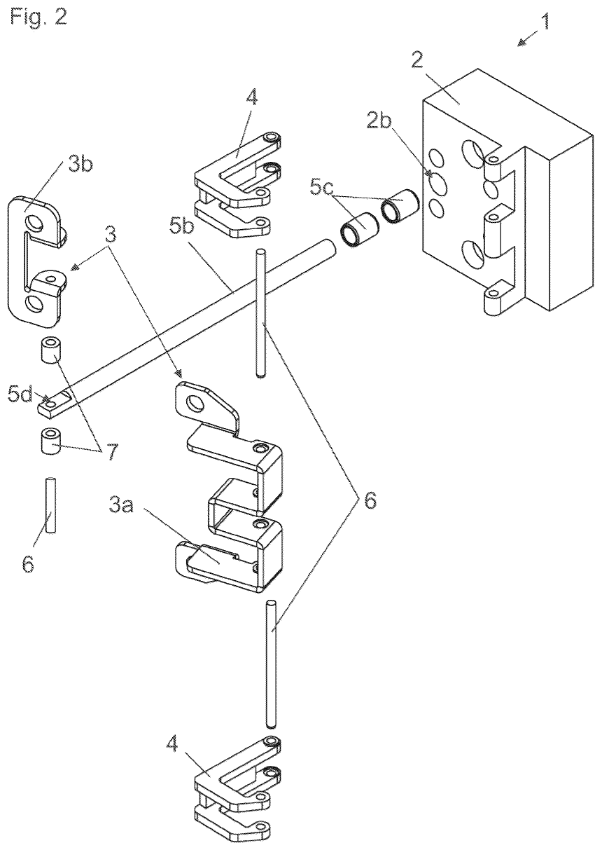

FIG. 2 shows an exploded representation of a fitting 1. A first fitting part 2 and a two-part second fitting part 3, consisting of a first part 3a and a second part 3b, can be seen.

The first fitting part 2 has a recess 2b, into which two mounting elements 5c can be inserted. The mounting elements 5c can be made of a different material from the first fitting part 2, for example in order to achieve better sliding properties. It is also conceivable that only one mounting element 5c or alternatively also more than two mounting elements 5c is/are provided.

A guide element 5b is guided in the mounting elements 5c. In the present case, both the mounting elements 5e and the guide element 5b are of circular cross section, but essentially any other cross section is conceivable.

The guide element 5b has a connecting section 5d, via which the guide element 5b can be connected to the second part 3b of the second fitting part 3. For this, a hole which can receive a connecting pin 6 is provided in the connecting section 5d. Holes for receiving the connecting pin 6 are also provided in the second part 3b, whereby an articulated connection between guide element 5b and second fitting part 3 is implemented.

The articulated levers 4 are also connected in an articulated manner to the first fitting part 2 or the first part 3a of the second fitting part 3 via connecting pins 6. In the present example, two articulated levers 4 are provided, which brings with it the advantage that higher forces and moments can be absorbed. However, only one articulated lever 4 or more than two articulated levers 4 can also be provided.

In particular, it is also evident from the following figures that both articulated levers 4 are in each case connected in an articulated manner to the first fitting part 2 or the second fitting part 3 via the same hinge pins 2a, 3c, respectively. The articulated levers 4 can thus move not independently, but only at the same time as each other. The second articulated lever 4 thus merely serves to structurally reinforce the first articulated lever 4.

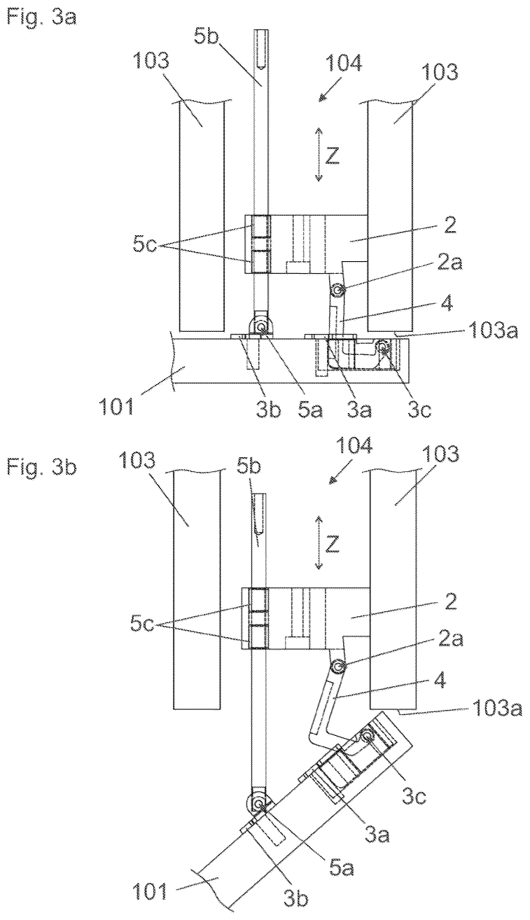

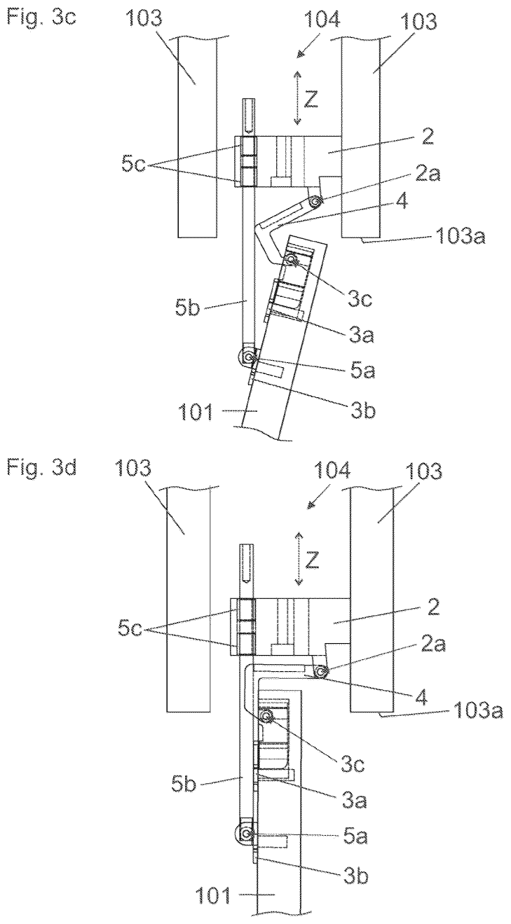

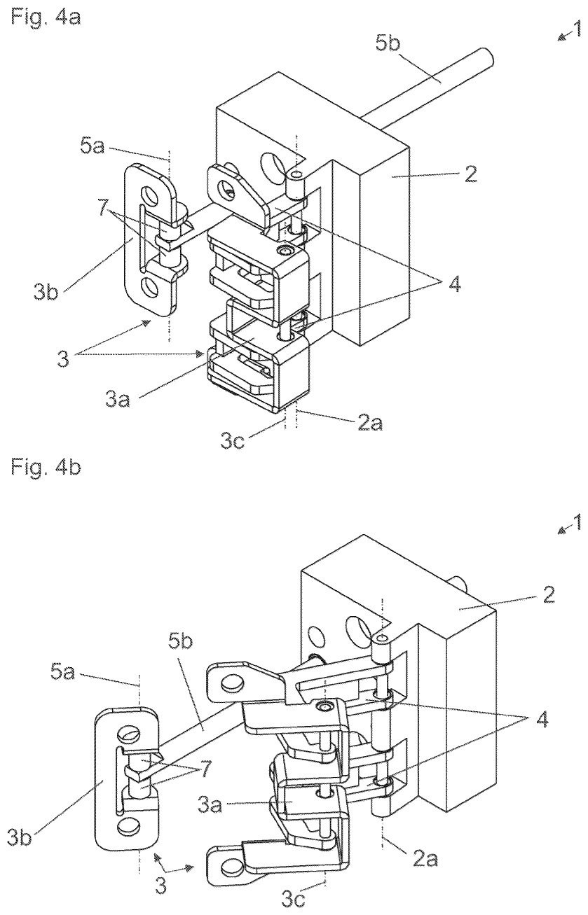

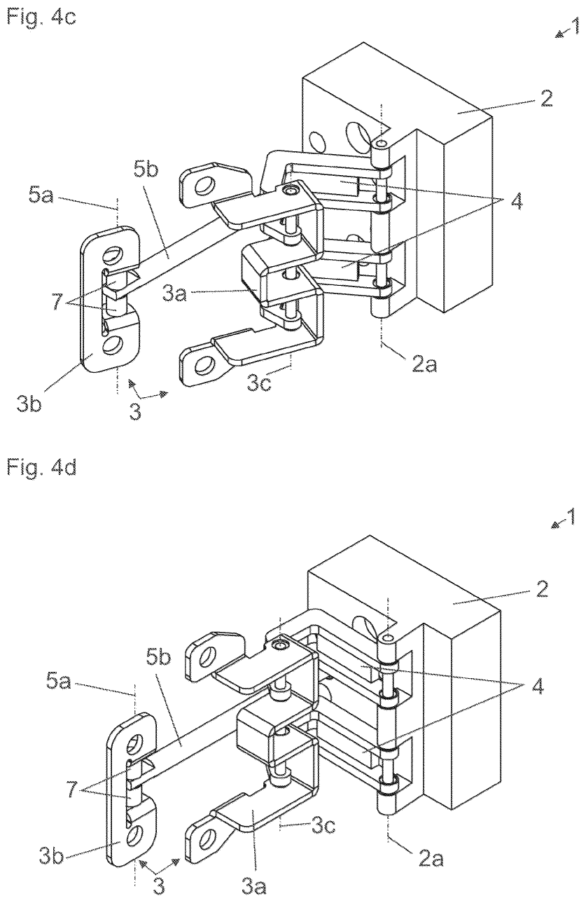

FIGS. 3a to 3d show top views of a part of a piece of furniture 100 in various steps during the transfer of the piece of furniture 100 from a first into a second position, and FIGS. 4a to 4d show perspective views of a fitting 1 in the same steps.

The fitting 1, and thus the piece of furniture 100, is in a first position in FIGS. 3a and 4a. It can be seen that the pivoting element 101 covers a front side 103a of the side wall 103 substantially completely. The guide element 5b is arranged substantially completely inside the cavity 104.

The pivoting element 101 has already been pivoted to a certain extent in FIGS. 3b and 4b. It can be seen that the guide element 5b guided in the mounting elements 5c has been linearly displaced. The articulated levers 4 have also been pivoted. A trajectory, along which the pivoting element 101 is pivoted, is defined via the articulated levers 4 and the arrangement of the hinge pins 2a, 3c and 5a.

The pivoting element 101 has been pivoted still further in FIGS. 3c and 4c and into the second position in FIGS. 3d and 4d. It can be seen that the pivoting element 101 is guided by the articulated levers 4 and the arrangement of the hinge pins 2a, 3c, 5a such that the front side 103a of the side wall 103 is concealed in the first position, but in the second position is arranged parallel to the side wall 103 and can travel into a cavity 104 formed by the side wall 103 and a further side wall 103. This traveling movement is effected in a depth direction Z of the stationary support 102 or of the cavity 104.

### LIST OF REFERENCE NUMBERS

1 fitting
2 first fitting part
   2a first hinge pin
   2b recess
3 second fitting part
   3a first part
   3b second part
   3c second hinge pin
4 articulated lever
5 guide device
   5a third hinge pin
   5b guide element
   5c mounting element
   5d connecting section
   5e sliding elements
6 connecting pin
100 piece of furniture
101 pivoting element
102 stationary support
103 side wall
   103a front side
104 cavity
105 folding sliding door
106 interior space
Z depth direction

1. A fitting for movably mounting a pivoting element, in particular a furniture part, a door or a window, relative to a stationary support, comprising:
a first fitting part arranged or arrangeable on a stationary support,
a second fitting part arranged or arrangeable on a pivoting element, wherein the first fitting part and the second fitting part are formed movable, preferably pivotable, relative to each other,
at least one articulated lever, which is connected in an articulated manner to the first fitting part via a first hinge pin and in an articulated manner to the second fitting part via a second hinge pin,
wherein a guide device is provided, wherein the guide device is mounted linearly displaceably on or in one of the two fitting parts and connected in an articulated manner to the other of the two fitting parts via a third hinge pin, wherein the third hinge pin is formed separate and at a distance from the first hinge pin and/or the second hinge pin,
wherein at least two, preferably precisely two, articulated levers are provided, wherein the at least two articulated levers are in each case connected in an articulated manner to the first fitting part via the first hinge pin and in an articulated manner to the second fitting part via the second hinge pin.

2. The fitting according to claim 1, wherein the at least one articulated lever is formed substantially L-shaped.

3. The fitting according to claim 1, wherein the guide device comprises a guide element and a mounting element, wherein the guide element is mounted linearly displaceably in the mounting element.

4. The fitting according to claim 3, wherein the guide element has a connecting section, via which the guide element is connected in an articulated manner to one of the two fitting parts at a third fastening point.

5. The fitting according to claim 3, wherein the guide element has a circular or polygonal cross-sectional area.

6. The fitting according to claim 3, wherein the mounting element comprises at least one sliding element, preferably two.

7. The fitting according to claim 6, wherein the at least one sliding element is arranged in a recess in the first fitting part, wherein the guide element is guided linearly displaceably in the sliding element.

8. The fitting according to claim 1, wherein the second fitting part is formed in two parts.

9. The fitting according to claim 8, wherein the second hinge pin is allocated to a first part of the second fitting and the third hinge pin is allocated to a second part of the second fitting.

10. A piece of furniture comprising a pivoting element, a stationary support, and the fitting according to claim 1, wherein the pivoting element is formed as a movable furniture part and the stationary support is formed as a furniture carcass.

11. The piece of furniture according to claim 10, wherein the pivoting element can be moved by means of the fitting between a first position, in which the pivoting element at least partially covers a front side of the side wall, and a second position, in which the pivoting element can travel in a depth direction of the stationary support.

12. The piece of furniture according to claim 11, wherein the stationary support has at least one side wall, wherein the pivoting element is arranged substantially parallel to the side wall in the second position.

13. The piece of furniture according to claim 12, wherein the stationary support has at least two side walls, wherein the at least two side walls form a cavity, into which a pivoting element can travel in the depth direction of the stationary support in the second position.

14. The piece of furniture according to claim 10, wherein the fitting is a first fitting of at least two fittings.
